(19) United States
(12) Patent Application Publication
(10) Pub. No.: US 2012/0208268 A1
(43) Pub. Date: Aug. 16, 2012

(54) MEDIA AND METHOD FOR CELL SEPARATION

(75) Inventors: ANDREAS AXÉN, UPPSALA (SE); ANTON BELETSKII, NISKAYUNA, NY (US); FREDRIK ELWINGER, UPPSALA (SE); GUNNAR HAGSTRÖM, UPPSALA (SE); DEIDRE A. NELSON, NISKAYUNA, NY (US)

(73) Assignee: GE HEALTHCARE BIO-SCIENCES AB, UPPSALA (SE)

(21) Appl. No.: 13/456,723

(22) Filed: Apr. 26, 2012

Related U.S. Application Data
(62) Division of application No. 12/518,284, filed on Jun. 9, 2009.

(30) Foreign Application Priority Data
Feb. 8, 2007 (SE) 0700333-8

(51) Int. Cl. C12N 5/00; C12M 1/00

(52) U.S. Cl. 435/325; 435/283.1

(57) ABSTRACT

The present invention relates to a separation media and a method for separation of cells from different cell sources, such as umbilical cord blood, using the separation media to obtain the desired cells, such as stem cells. The separation media has beads with a diameter of 200-500 μm and is provided with cell separation ligands. The cell specific ligands are preferably CD3 and CD19 for depletion of B and T cells and production of a stem cell rich product.

### CROSS-REFERENCE TO RELATED APPLICATIONS

This application is a divisional filing of U.S. patent application Ser. No. 12/518,284 filed Jun. 9, 2009, now abandoned, which is a filing under 35 U.S.C. §371 and claims priority to international patent application number PCT/SE2008/000074 filed Jan. 28, 2008, published on Aug. 14, 2008, as WO 2008/097155, which claims priority to patent application number 0700333-8 filed in Sweden on Feb. 8, 2007.

### FIELD OF THE INVENTION

The present invention relates to a separation media and a method for separation, preferably depletion, of cells from different cell sources, such as umbilical cord blood, using said separation media to obtain the desired cells, is such as stem cells. The separation media comprises beads with a large diameter and is provided with cell separation ligands.

### BACKGROUND OF THE INVENTION

Stem cells are immature subpopulations of cells that have the potential to differentiate into a wide variety of specialized cell types such as bone, muscle, pancreas, liver, or blood cells. These undifferentiated cells have the ability of self-renewal which preserves their continuous supply. Embryonic stem cells (ESCs) are commonly derived from 4- to 5-day-old embryos. At this stage, the embryos are spherical and are known as blastocysts. Each blastocyst consists of 50 to 150 cells and includes three structures: an outer layer of cells, a fluid-filled cavity, and a group of about 30 pluripotent cells at one end of the cavity. This latter group of cells called the inner cell mass, form all the cells of the body. Adult stem cells on the other hand are undifferentiated cells that are found in small numbers in most adult tissues. They are also found in humans of other ages and can be extracted from umbilical cord blood. The primary roles of adult stem cells in the body appear to be to maintain and repair the tissues in which they are found. They are usually thought of as multipotent cells, giving rise to a closely related family of cells within the tissue. An example is haematopoietic stem cells, which form all the various cells in the blood. Pluripotent haematopoietic stem cells are io currently of interest in research, as they can differentiate into neurons, glia, skeletal muscle cells, heart muscle cells, and liver cells. A variety of other stem or progenitor cells are now known and most would appear to offer promise for use in various cellular based therapies. In this they match several other cell types (e. g. lymphocytes, dendritic cells) which in a native or genetically modified is form also hold promise as regards cell therapeutic agents and products.

Blood from the placenta and umbilical cord, which are left over after birth, is a rich source of haematopoietic stem cells. As noted above so-called umbilical cord stem cells have been shown to be able to differentiate into bone cells and neurons, as well as the cells lining the inside of blood vessels.

In cell therapy, it is often necessary to both purify and concentrate subpopulations of cells in a sample. In some stem cell therapies there is a need to use adult stem cells from the patient to be treated, and to expand said cells in culture, treat them to differentiate into the desired cells, and then to reintroduce them into the patient. The use of the patient's own homologous cells for transplantation will reduce the possibility that they might be rejected by the immune system. However such samples might contain cancerous or other cells that should be removed before the sample can be of further use. Of course heterologous transplantation is also of great value if there is correct matching of transplanted cells with the host. Independent of cell source for transplantation, it is often necessary to both purify and concentrate subpopulations of cells in a sample. The purification and concentration may be performed by enriching or depleting specific cells from the cell source. For example it is known that depletion of CD3 and CD19 cells may improve engraftment and reconstitution of stem cells after cell transplantation (Wolfgang A. Betghe et al, Experimental Haematology 34 (2006) 1746-1752).

Several methods for separating cells are known. The most common involves methods where separation is dependent on cell physical properties such as density and size. This includes methods based on differential migration in a fluid flow (field flow fractionation) or in sedimentation field (centrifugation) or in combination (elutriation). Differential sedimentation is often performed in solutions or colloidal dispersions of varying inherent densities, either in discontinuous or continuous (gradient) form.

Currently magnetic beads carrying mAbs directed towards various cell surface marker proteins is the standard for cell separation experiments based on affinity.

For example, WO96/28732 describes enrichment of hematopoietic cells by depletion using magnetically coupled reagents specific for one or more cell surface antigens expressed by non-dendritic hematopoietic cells.

WO2006/112771 describes magnetic beads suitable for, for example, isolation of proteins and cells. The magnetic beads are composite beads with an inner core of metal particles, which are coated with an inert synthetic polymer and these are then enclosed in a hydrophilic porous polymer, preferably agarose. This provides porous biocompatible beads without metal leakage. The agarose layer is preferably provided with ligands having affinity for selected biomolecules.

In spite of the various known cell separation methods, there is a great focus on finding new formats and technologies for performing cell separation experiments.

### SUMMARY OF THE INVENTION

The present inventors provide a new format for cell separation experiments that offers convenient handling and show good results regarding cell depletion of selected cell lines. The format is a separation media based on large porous beads, conjugated with selective affinity ligands.

In a first aspect, the invention relates to a separation media for cell is separation comprising porous beads having a diameter of about 200 to 500 μm and being provided with cell specific ligands. Preferably, the beads or spheres are selected to have an average diameter ranging from about 250 to 400 μm. It is desirable that the size of spheres is relatively homogeneous.

The inventors have found that this size of the beads is especially useful for separating cells and organelles because of the void volume that allows the passage of cell material trough a bed of such beads without sieving effects and also leaves an enough large volume for accommodating the bound cell material.

The cell specific ligands may be directed against any cell surface marker, such as an antigen or receptor, on any cell or cell organelle. The cell specific ligands may be any type of ligands, such as antibodies, aptamers, affibodies, lectins, proteins. A preferred application is separation/depletion of cells from cell samples, such as umbilical cord samples.

Preferably the separation media is a natural media such as a polysaccharide or carbohydrate media, for example made of agarose or dextran. Alternatively, the media is synthetic.

For stem cell depletion applications, the cell specific ligands are preferably directed against CD3 and CD19. In this way, a majority of both B- and T-cells will be depleted from the cell sample, leaving desired stem cells unbound in the sample for easy collection from the bound cells.

In another embodiment, the cell specific ligands are directed against cell organelle specific markers. This media allows separation of cell organelles, such as mitochondria, ribosomes and nuclei, from cell samples.

In a second aspect, the invention relates to a method for separation of cells and/or organelles, wherein a media having a diameter of 200-500 μm and being provided with cell specific ligands is disposed in a pre-packed column, and wherein a cell sample is fed to the column from a cell feeding bag into the column.

The method could either be a negative selection/depletion method or a positive selection/enrichment of cell samples depending on the chosen ligands and the desired end product.

Preferably, the separated cells or organelles are collected in a cell collection bag. In case of for example separated stem cells, these can conveniently be supplied from the bag to a patient in need thereof.

Preferably, the cell bags for feeding and collection are conventional blood sampling bags which are coupled to the pre-packed column comprising the media of the invention.

In a third aspect, the invention provides a system for use in the above described method, comprising a column with a cell separation media having a diameter of 200-500 μm and being provided with cell or organelle specific ligands, as well as one cell feeding bag at the upper end of the column and one cell collecting bag at the lower end of the column.

Preferably, the system is a closed system to avoid contamination, wherein the cell sampling bags are directly connected to the column. For stem cell applications, the cell specific ligands are preferably directed against the cell surface markers CD3 and CD19.

The new format and technology according to the invention are easy to handle and offer the opportunity to work in closed systems. Furthermore, the format can be combined with ligands directed towards various cell surface or organelle markers and is suited for small as well as large scale separations.

### BRIEF DESCRIPTION OF THE DRAWINGS

FIG. 1 is a diagram showing cell depletion results using the new separation format according to the invention.

### DETAILED DESCRIPTION OF THE INVENTION

The present inventors have found a new cell separation format showing very good results in depletion experiments of stem cells and that offers a convenient handling. The new format is based on large polysaccharide beads equipped with affinity ligands directed towards various cell surface markers.

Below a non-limiting example of the invention is described. It is to be understood that any cell or organelle specific ligand could be used in combination with the media having the specific size described above.

### Depletion Experiment

SEPHAROSE™ 6MB (GE Healthcare Bio-Sciences AB) beads activated with CNBr were conjugated with commercially available mAbs against CD3. This material was packed into columns equipped with crude end filters. This ready to use device was charge with portions of target CD3 positive cells in mixture with CD3 negative/CD19 positive reference cells.

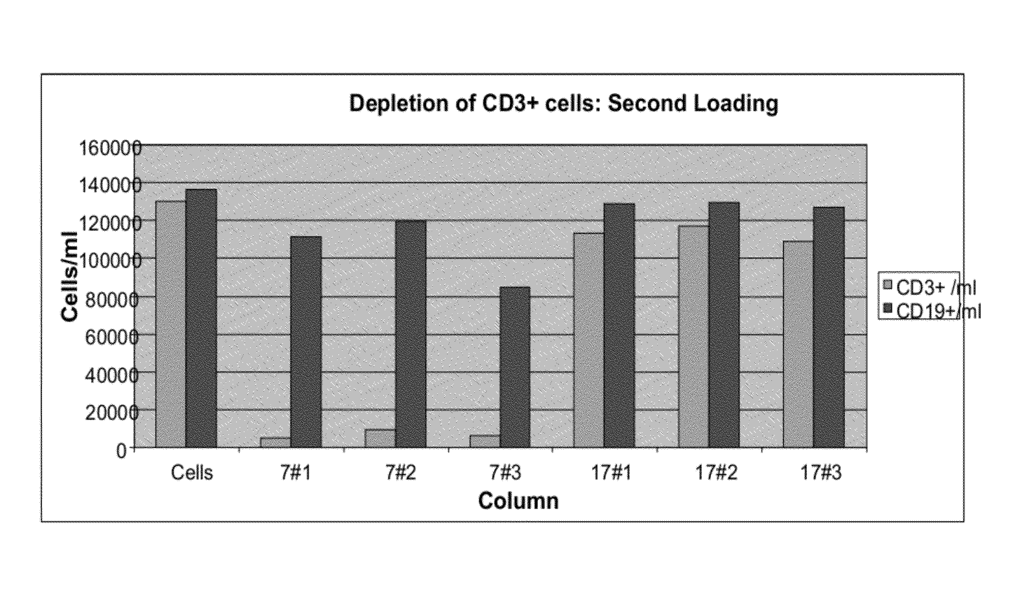

This closed column format allows for a convenient separation of cell lines by feeding the cell suspension to the column with e.g. a syringe. After 30 minutes of incubation the cell suspension was eluted from the column and analysed with FACS. FACS-data indicated a high degree of depletion of the target cell line (FIG. 1).

FIG. 1 shows schematic use of pre-packed affinity columns for cell separation according to the invention. The first double-bar from the left in the figure represents count of cells in mixture before applying the material to the column. The next three double-bars represent cell count in eluted material from an affinity column with anti-CD3 antibodies to which portions of cell mixture has been charged, in triplicate experiments. The last three double-bars represent triplicate control experiments where the same cell mixture has been passed trough columns charged with beads carrying a control antibody.

These experiments show that the media according to the present invention could selectively and efficiently deplete the target CD3 cells from the sample.

Thus, the present invention provides a material readily functionalised with specific affinity ligands, pre-packed in ready to use, disposable columns that can easily be fed with cell samples in a convenient fashion.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-6. (canceled)

7: A method for separation of cells and/or organelles, comprising disposing in a pre-packed column a media having a diameter of 200-500 μm and being provided with cell specific ligands and feeding a cell sample to the column from a cell feeding bag.

8: The method of claim 7, wherein the separated cells or organelles are collected in a cell collection bag.

9: The method of claim 8, wherein the cell bags for feeding and collection are blood sampling bags.

10: A system for use in the method of claim 7, comprising a column with a cell separation media having a diameter of 200-500 μm and being provided with cell or organelle specific ligands, as well as one cell feeding bag at the upper end of the column and one cell collecting bag at the lower end of the column.

11: The system of claim 10, which is a closed system wherein the cell sampling bags are directly connected to the column.

12: The system of claim 10, wherein the cell specific ligands are directed against CD3 and CD19, and wherein stem cells are collected.
